(19) United States
(12) Patent Application Publication
(10) Pub. No.: US 2013/0149278 A1
(43) Pub. Date: Jun. 13, 2013

(54) Insect Control Composition

(71) Applicant: Nisus Corporation, Rockwood, TN (US)

(72) Inventors: Jeffrey D. Lloyd, Knoxville, TN (US); Ronald T. Schwalb, Knoxville, TN (US)

(73) Assignee: NISUS CORPORATION, Rockwood, TN (US)

(21) Appl. No.: 13/693,307

(22) Filed: Dec. 4, 2012

Related U.S. Application Data
(60) Provisional application No. 61/567,682, filed on Dec. 7, 2011.

(51) Int. Cl. A01N 59/14; A01N 43/16

(52) U.S. Cl. CPC A01N 59/14; A01N 43/16
USPC 424/84

(57) ABSTRACT

A composition that attracts insects and which is sufficiently ingested by the insects as to kill the insects, the composition having a boron-containing compound; a saccharide, and a solvent. The composition optionally includes a preservative, at least one organic acid, or an alkali or an alkaline earth sale thereof, and optionally at least one hygroscopic agent.

### CROSS REFERENCE TO RELATED APPLICATIONS

This application claims the benefit of U.S. Provisional Application No. 61/567,682, filed Dec. 7, 2011.

### FIELD

The present disclosure relates to the field of pest control, and more particularly to a composition and method for killing insects such as ants and mosquitoes.

### BACKGROUND

Insects such as mosquitoes and ants are undesired pests and nuisances commonly found in outdoor areas, particularly in areas with standing water or excess moisture. Not only are insects an undesired pest, biting insects such as mosquitoes also pose health risks as carriers of diseases such as malaria, West Nile Virus and Yellow Fever.

Repellants are available that discourage insects such as mosquitoes from landing on a particular surface or in a particular area. Repellants generally only act to repel an insect from a particular area or surface without having an effect on the population of the insect. Additionally, insecticides are available for use in controlling insect populations, however, these insecticides may be difficult to apply effectively and must be applied directly on the location of the insects sought to be eradicated.

Accordingly, there is a need for a solution that is attractive to an insect so as to lure in a large number of the insect while being capable of eliminating the insects attracted to the solution.

### SUMMARY

In a first aspect, the present disclosure relates to a diluted insect control composition including: from about 0.1 to about 10 percent, by weight, of a boron-containing compound; from about 1 to about 35 percent, by weight, of a saccharide; from about 10 to about 97 percent, by weight, of at least one solvent; optionally, from about 0.05 to about 3 percent, by weight, of at least one organic acid, or an alkali or an alkaline earth salt thereof; and optionally, from about 0.5 to about 10 percent, by weight, of at least one hygroscopic agent (or humectant) such as a polyhydric alcohol, wherein all percentages are based on the composition in diluted form as diluted by the presence of the solvent.

In one embodiment, the boron-containing compound comprises at least one compound selected from the group consisting of orthoboric acid, metaboric acid, boric oxide, sodium borates, potassium borates, lithium borates, boron esters, boronic acids and mixtures thereof. In another embodiment, the at least one boron-containing compound comprises sodium tetraborate decahydrate.

In one embodiment, the at least one solvent comprises water. In another embodiment, the at least one organic acid, alkali or alkaline earth sale comprises sodium propionate. In yet another embodiment, the saccharide comprises at least a sugar selected from the group consisting of sucrose, glucose, fructose, lactose and combinations thereof. In another embodiment, the at least one hygroscopic agent is selected from the groups consisting of glycols, glycerol and combinations thereof.

In a second aspect, the disclosure relates to a concentrated insect control composition including: from about 10 to about 50 percent, by weight, of a boron-containing compound; from about 10 to about 99 percent, by weight, of a saccharide; from 0 to about 20 percent, by weight, of at least one solvent; optionally, from about 0.5 to about 10 percent, by weight, of at least one organic acid, or an alkali or an alkaline earth salt thereof; and optionally, from about 0.5 to about 10 percent, by weight, of at least one hygroscopic agent (or humectant) such as a polyhydric alcohol, wherein all percentages are based on the composition in concentrated form.

In a third aspect, the disclosure relates to a method of controlling insects by treating at least one area infested with insects with the diluted pest control composition in an amount effective to kill and/or repel the insects, wherein the insects are selected from the group consisting of nonflying insects such as ants and flying insects such as mosquitoes.

### DETAILED DESCRIPTION

The present disclosure provides an insect control composition. The composition is provided in both a concentrated form and a diluted form. The composition may be stored, shipped, displayed for sale and the like in the concentrated form. The concentrated form may be diluted with a solvent to provide the diluted form, which is placed in an environment having insects for attracting and killing the insects.

The insect control composition generally includes at least one boron-containing compound, and at least one saccharide. The boron-containing compound is present to kill insects. The saccharide is present to attract insects. In some instances, the composition may further include at least one organic acid or alkali or alkaline earth salt that also helps attract insects and a hygroscopic agent (sometimes called a humectant) that helps keep the formulation liquid. These compositions also maintain desired pH conditions to inhibit fermentation, and to otherwise stabilize the composition to maintain desired attractiveness to insects. It has also been discovered that the combination of borate and organic acid prevents fermentation of the formulation that otherwise turns the sugar to alcohol which then becomes less attractive. Optionally a preservative such as sodium or potassium metabisulfate or a combination of the two may be used. A solvent may be provided in both the concentrated and diluted forms. In diluted form, the solvent may be included to dilute the boron containing compound to an amount sufficiently low so as to not repel insects or cause insects not to ingest the composition, yet, sufficiently high to kill insects that ingest the composition.

Optionally, the insect control composition may use a non-boron-containing compound as an insecticide. In one embodiment, the insect control composition includes both a boron-containing compound and a non-boron-containing compound as the insecticide. Alternatively, the insect control composition may have a non-boron-containing compound only as the insect control composition. The insecticide can include, for example, various insect growth regulators. The insecticide can be substantially non-repellant to insects. The insecticide can include, for example, a stomach poison, contact insecticide, insect growth regulator and like insecticides, or combinations thereof, for example, one or more of pyriproxyfen, methoprene, fenoxycarb, hydramethylnon, sulfuramid, fipronil, abamectin, propoxur, spinosad, imidacloprid and mixtures thereof.

In diluted form, the composition preferably includes from about 0.1 to about 5 percent, by weight, of the boron-containing compound. In concentrated form, the composition may include from about 10 to about 50 percent, by weight, of the boron-containing compound. Examples of suitable boron-containing compounds include orthoboric acid, metaboric acid, boric oxide, sodium borates, potassium borates, lithium borates, boron esters, boronic acids, and sodium tetraborate decahydrate. The boron-containing compound may also comprise a combination of the above compounds. A preferred boron-containing compound is sodium tetraborate decahydrate.

Additionally, the insect control composition in diluted form preferably includes from about 1 to about 35 percent, by weight, of a saccharide. In concentrated form, the composition preferably includes from about 10 to about 99 percent, by weight, of the saccharide. Examples of suitable saccharides include sugars such as sucrose, glucose, fructose, lactose and high fructose corn syrup. A combination of the exemplary saccharides may also be used. A preferred saccharide is sucrose.

The insect control composition in diluted form may include from about 10 to about 97 percent, by weight, of a solvent suitable to substantially solubalize the composition. In concentrated form, the composition may include from about 0 to about 20 percent, by weight, of the solvent. A preferred solvent is water, although other suitable solvents may also be used which are suitable to substantially solubalize the composition. Other suitable solvents may include glycerol, alcohols or mixtures thereof. Mixtures of water and the aforementioned solvents may also be used.

The solvent typically makes up from about 60 to about 98 percent, by weight, of the final, diluted composition. The diluted composition may be prepared by combining from about 5 to about 50 percent, by weight, of the concentrate composition with from about 50 to about 95 percent, by weight, of the solvent.

In an alternative embodiment, the insect control composition may be formed without a solvent. In this embodiment, the insect control composition may exist in a solid or granular form.

Optionally, the insect control composition may include an organic acid or an alkali or alkaline earth salt thereof. In diluted form, the composition preferably includes from about 0.05 to about 3 percent, by weight, of the organic acid, or alkali or alkaline salt thereof. Alternatively, the composition in concentrated form preferably includes from about 0.5 to about 10 percent, by weight, of the organic acid, or alkali or alkaline earth salt. Examples of a suitable organic acid, or alkali or alkaline earth salt include formate, potassium sorbate, calcium citrate and sodium propionate. Most preferably, the organic acid, or alkali or alkaline earth salt is sodium propionate.

The insect control composition may also optionally include a hygroscopic agent or humectant. In diluted form, the composition preferably includes from about 0.5 to about 10 percent, by weight, of the hygroscopic agent or humectant. In concentrated form, the composition may include from about 5 to about 50 percent, by weight, of the hygroscopic agent or humectant. The hygroscopic agent or humectant may be polyhydric alcohol. Preferably, the hygroscopic agent or humectant is a glycerol or a glycol, such as ethylene glycol, diethylene glycol or propylene glycol.

The presently disclosed composition may be used to control a variety of flying and nonflying insects. For example, the composition may be effectively used to kill ants, mosquitoes, and other various insects. The present composition advantageously attracts insects using the sugar component and organic acid and contains an effective amount of an insecticide or borate-containing compound to kill flying and nonflying insects without repelling the insects from the composition. Additionally, the composition is resistant to fermentation during storage and shipping and after application and so remains attractive to insects for an extended period of time. It has also been found that the formulation may be applied to plant, tree and shrubs without causing phytotoxicity, the composition having little to no toxic effect on plant growth.

According to the present disclosure, the diluted insect control composition may be applied to a dish in an amount effective to kill the attracted insects. In one preferred embodiment, the composition is placed in an insect accessible container, such as a dish or bowl or the like that is then placed on the ground in a location frequented by unwanted insects. The insects are attracted to the composition containing saccharide and are killed upon ingesting a lethal amount of the boron or insecticide containing composition. Alternatively, a bait trap or receptacle may be used.

In another preferred embodiment, the diluted insect control composition is applied to at least one surface of an insect infested building or structure in an amount effective to kill the insects. That is, it has been discovered that the composition may be applied to foliage, for example, and that insects are attracted to the treated foliage and ingest the composition in amounts effective to kill the insects.

The following non-limiting example illustrates various additional aspects of the disclosure. Unless otherwise indicated, percentages are by weight based on the overall weight of the composition.

### Example 1

In this Example, a liquid insect control composition in accordance with the present disclosure was prepared having the following composition:

1% sodium tetraborate decahydrate

30% sucrose

68% water

0.4% sodium propionate

The effectiveness of the liquid composition was tested using ants and other outdoor insects as a test species. Two identical trays were used with each being made of approximately an eight-inch diameter large tray with a smaller tray located within the large tray. The identical trays were placed in close proximity to each other in an outdoor location. In a first tray, the insect control composition described above was applied. A second tray was provided immediately adjacent the first tray, with the second tray containing an identical amount, by weight, of a commonly available liquid ant bait.

Each tray was observed over a period of approximately 7 hours. A substantially larger number of insects, comprising primarily ants, were observed present on the first tray having the above described insect control composition. The second tray having the alternative liquid ant bait was observed to have substantially fewer ants and insects than the first tray.

Throughout the observation of the two trays, more ants and insects were observed to be present on the first tray having the composition according to the disclosure than were observed to be present on the second tray having a conventional liquid ant bait.

### Example 2

In this example, four different samples containing the various compositions described above were field tested in an outside area frequented by Argentine ants. Specifically, the compositions and the number of ants that were attracted to each composition during the test period are detailed in the table below.

| | Boron- | | | | Number |
|---|---|---|---|---|---|
| | Containing | | | Organic | of |
| | Compound | Saccharide | Solvent | Acid | Ants |
| Sample 1 | 5% Borax | 55% Sucrose | 25% Water | None | 3 |
| | | 17% Glucose | | | |
| Sample 2 | 5% Borax | 22% Sucrose | 73% Water | None | 23 |
| Sample 3 | 1% Borax | 22% Sucrose | 77% Water | None | 52 |
| Sample 4 | 1% Borax | 22% Sucrose | 76.5% Water | 0.5% | 300 |
| | | | | Sodium | |
| | | | | Propi- | |
| | | | | onate | |

As illustrated in the table above, the most effective composition during this test was the composition comprising 1% Borax, 22% Sucrose, 0.5% Sodium Propionate and the remainder being water as a solvent. During the test period, only three ants visited the Sample 1 composition containing the highest amount, by weight, of a saccharide. Sample 2 contained only 22% by weight of a saccharide and 5% of the boron-containing compound. With this composition, 23 ants visited Sample 2 during the test period. Sample 3, having 1% of a boron-containing compound and 22% by weight of a saccharide, was visited by 52 ants. Sample 4 proved to be the most effective, having a composition of 1% Borax, 22% Sucrose, 0.5% Sodium Propionate with the remainder comprising water as a solvent. Sample 4 attracted 300 ants during the test period. Additionally, while the other three samples were visited by the ants only once, ants that visited Sample 4 were observed as continuing to feed at Sample 4 after the initial visit during the testing period.

### Example 3

In this example, various concentrations of the sample 4 composition of example 2 above containing 1% Borax, 22% sucrose, 76.5% water and 0.5% sodium propionate, were diluted in 5% sucrose and placed in a test cage containing yellow fever mosquitoes (Aedes aegypti). Six day old, sugar starved, female yellow fever mosquitoes were placed ten to a cage. 2 μl of food coloring was added to each concentration to color the sugar meal. Five total cages were set up with the dilutions of sample 4 being 0%, 10%, 20%, 50% and 100%. 500 μl of the sample 4 formulation diluted with sucrose solution were placed in a cotton roll on top of the cage for 3 hours. The mosquitoes were then chilled for 3 minutes in a 4° C. refrigerator for 3 minutes to anaesthetize them. After being anaesthetized, the mosquitoes were checked for a distended abdomen and blue color through the cuticle to assess whether the mosquitoes had fed or not.

| | | | | | 120 | 144 |
|---|---|---|---|---|---|---|
| | 24 Hours | 48 Hours | 72 Hours | 96 Hours | Hours | Hours |
| 0% | 0 | 0 | 0 | 0 | 0 | 0 |
| 10% | 0 | 0 | 0 | 0 | 0 | 0 |
| 20% | 0 | 0 | 0 | 1 | 2 | 2 |
| 50% | 0 | 1 | 2 | 2 | 2 | 2 |
| 100% | 1 | 4 | 8 | 9 | 9 | 9 |

The table above illustrates the number of mortalities for the various sample 4 formulation diluted with 5% sucrose. By using 100% of the sample 4 composition with no dilution, 8 of the 10 yellow fever mosquitoes died within 72 hours, with 9 having died within 96 hours.

### Example 4

In this example, various concentrations of the sample 4 composition used in example 2 were diluted in 5% sucrose and placed in test cages containing yellow fever mosquitoes. Six day old, sugar starved mosquitoes were placed ten to a cage. 2 μl of food coloring was added to each formulation to color the sugar meal. Five total cages were set up with the dilutions of sample 4 being 0%, 1%, 10%, 20% and 50%. 500 μl of the sample diluted with sucrose solution was placed in a cotton roll on top of the cage for 3 hours. The mosquitoes were then chilled for 3 minutes in a 4° C. refrigerator for 3 minutes to anaesthetize them. After being anaesthetized, the mosquitoes were checked for a distended abdomen and blue color through the cuticle to assess whether the mosquitoes had fed or not.

| | Number of Mosquitoes |
|---|---|
| | Taking Sugar Meal |
| 0% | 4 |
| 1% | 8 |
| 10% | 9 |
| 20% | 8 |
| 50% | 9 |

The table above illustrates the number of mosquitoes that took a sugar meal from the sample diluted with sucrose. 24 hours after being removed from the cages, a human arm was offered to the mosquitoes and all treated mosquitoes fed freely. The mosquitoes were dissected at 24, 48 and 72 hours post-treatment to monitor the state of the blood meal in the crop of the mosquito, the state of the blood meal and the deposition of a yolk of the mosquitoes.

| | | |
|---|---|---|
| Sugar Meal | Blood Meal | Yolk Deposition |

24 Hours Post Blood Meal

| | | | |
|---|---|---|---|
| 0% | Crop Empty | Blood Black and In Bolus | 120 μm of Yolk |
| 1% | Crop Empty | Blood Black and In Bolus | 120 μm of Yolk |
| 10% | Crop Empty | Blood Black and In Bolus | 80 μm of Yolk |
| | But Tinged | | |
| | Red | | |
| 20% | Crop Full | Blood Black and In Bolus | 10 μm of Yolk |
| 50% | Crop Full | Blood Black and In Bolus | 0 μm of Yolk |

48 Hours Post Blood Meal

| | | | |
|---|---|---|---|
| 0% | Crop Empty | Very Small Black Pellet | 400 μm of Yolk |
| 1% | Crop Empty | Very Small Black Pellet | 400 μm of Yolk |
| 10% | Crop Empty | Very Small Black Pellet | 240 μm of Yolk |
| 20% | Crop Has A | Very Small Black Pellet | 0 μm of Yolk |
| | Small | | |
| | Amount | | |
| | Left | | |
| 50% | Crop Full | Blood Black and In Bolus | 0 μm of Yolk |

72 Hours Post Blood Meal

| | | | |
|---|---|---|---|
| 0% | Crop Empty | Very Small Black Pellet | 400 μm of Yolk |
| 1% | Crop Empty | Very Small Black Pellet | 400 μm of Yolk |
| 10% | Crop Empty | Very Small Black Pellet | 300 μm of Yolk |
| 20% | Crop Empty | Very Small Black Pellet | 400 μm of Yolk |
| 50% | — | — | — |

The above table and example illustrate the impact that ingesting the sample solution diluted with sucrose has on mosquitoes and their ability to digest food and lay eggs. For example, after 48 hours the mosquitoes that ingested the 50% of the sample diluted by 5% sucrose had a yolk deposition of 0 μm. Thus, according to the example above, the mosquitoes were not only attracted to feed on the 50% sample solution, but the solution was also effective at substantially inhibiting ingestion and egg development in the mosquitoes.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated.

What is claimed is:

1. A diluted insect control composition including:
from about 0.1 to about 10 percent, by weight, of a boron-containing compound;
from about 1 to about 35 percent, by weight, of a saccharide;
from about 10 to about 97 percent, by weight, of at least one solvent;
optionally, from about 0.1 to about 3 percent, by weight, of a preservative selected from the group consisting of sodium metabisulfate, potassium metabisulfate, and mixtures thereof;
optionally, from about 0.05 to about 3 percent, by weight, of at least one organic acid, or an alkali or an alkaline earth salt thereof; and
optionally, from about 0.5 to about 10 percent, by weight, of at least one hygroscopic agent, wherein all percentages are based on the composition in diluted form as diluted by the presence of the solvent.

2. The composition of claim 1, wherein the at least one boron-containing compound comprises at least one compound selected from the group consisting of orthoboric acid, metaboric acid, boric oxide, sodium borates, potassium borates, lithium borates, boron esters, boronic or boronic acids and mixtures thereof.

3. The composition of claim 2, wherein the at least one boron-containing compound comprises sodium tetraborate decahydrate.

4. The composition of claim 1, wherein the at least one solvent comprises water.

5. The composition of claim 1, wherein the at least one organic acid, alkali or alkaline earth salt comprises sodium propionate.

6. The composition of claim 1, wherein the saccharide comprises at least a sugar selected from the group consisting of sucrose, glucose, fructose, lactose and combinations thereof.

7. The composition of claim 1, wherein the at least one hygroscopic agent is selected from the group consisting of glycols, glycerol and combinations thereof.

8. A concentrated insect control composition including:
from about 10 to about 50 percent, by weight, of a boron-containing compound;
from about 10 to about 99 percent, by weight, of a saccharide;
from 0 to about 20 percent, by weight, of at least one solvent;
optionally, from about 0.5 to about 10 percent, by weight, of at least one organic acid, or an alkali or an alkaline earth salt thereof; and
optionally, from about 0.5 to about 10 percent, by weight, of at least one hygroscopic, wherein all percentages are based on the composition in concentrated form.

9. The composition of claim 8, wherein the at least one boron-containing compound comprises at least one compound selected from the group consisting of orthoboric acid, metaboric acid, boric oxide, sodium borates, potassium borates, lithium borates, boron esters, boronic or boronic acids and mixtures thereof.

10. The composition of claim 9, wherein the at least one boron-containing compound comprises sodium tetraborate decahydrate.

11. The composition of claim 8, wherein the at least one solvent comprises water.

12. The composition of claim 8, wherein the at least one organic acid, or an alkali or an alkaline earth salt thereof comprises sodium propionate.

13. The composition of claim 8, wherein the saccharide comprises at least sugar selected from the group consisting of sucrose, glucose, fructose, lactose and combinations thereof.

14. The composition of claim 8, wherein the at least one hygroscopic agent is selected from the group consisting of glycols, glycerol and combinations thereof.

15. A method for controlling insects including:
treating at least one area infested with insects with the diluted pest control composition of claim 1 in an amount effective to kill and/or repel the insects,
wherein the insects are selected from the group consisting of nonflying insects such as ants and flying insects such as mosquitoes.
